(19) United States
(12) Patent Application Publication
(10) Pub. No.: US 2016/0021915 A1
(43) Pub. Date: Jan. 28, 2016

(54) FOOD STORAGE CONTAINER AND METHODS OF USE

(71) Applicant: Michael Wayne Baxter, East Jordan, MI (US)

(72) Inventor: Michael Wayne Baxter, East Jordan, MI (US)

(21) Appl. No.: 14/807,547

(22) Filed: Jul. 23, 2015

Related U.S. Application Data
(60) Provisional application No. 62/028,445, filed on Jul. 24, 2014.

(51) Int. Cl. A23L 1/18; A23P 1/08; B65D 43/16; B65D 85/60; A47J 47/02; B65D 8/00

(52) U.S. Cl. CPC A23L 1/1817; A47J 47/02; B65D 11/02; B65D 43/16; B65D 85/60; A23P 1/083

(57) ABSTRACT

A spherical food storage container with a lid for adding foods, or for extracting food is provided. The spherical food storage container can be stored as two or more pieces that may be assembled to form a spherical container for holding food, while providing a lid in a portion of one of the hemispheres for the addition of a food, or for extraction of the food. The container and the portions of the container are made of food grade plastic that is dishwasher safe. The food storage container is made from paper, cardboard, poly-vinyl chloride (PVC), plastic, ceramic, metal, wood, fiber glass, a glass reinforced plastic, or combinations thereof. In at least one embodiment, the container and the portions of the container are made of food grade plastic that is dishwasher safe.

### RELATED APPLICATIONS

This application claims priority benefit of U.S. Provisional Application Ser. No. 62/028,445 filed Jul. 24, 2014; the contents of which are hereby incorporated by reference.

### TECHNICAL FIELD

The present invention relates to food storage containers and more specifically to new and useful containers for the storage of cooked popcorn. The present invention further relates to food storage containers for the thorough application of additives to a stored food product.

### BACKGROUND

Popcorn is a favorite treat of many generations, and is enjoyed at home, or at events such as sports games and movie theatres. Popcorn is typically enjoyed plain, but many also prefer the addition of salt, butter, caramel, chocolate, or some other seasoning or topping to make the popcorn more enjoyable. In most cases, popcorn toppings are available in shakers or dispensers, except where caramel or chocolate is used, typically a consumer must purchase from a commercial vendor or store.

There are many known containers used for holding popcorn, such as bags, cups, boxes, and tubs. Most of these containers are made of paper, wax coated paper, cardboard, or plastic. In addition, many of the containers available are used in the microwave, and thus contain other chemicals or materials for the microwave processing and flavoring of popcorn. One shortcoming of many containers currently available for holding popcorn is that they do not include a lid and are thus used for immediate use only. Furthermore, all the food containers presently available only allow the addition of seasoning or toppings to the top layer of food, and none of the containers currently provided have the utility to provide a location and a method for the uniform addition of popcorn seasonings or toppings. Finally, none of the presently available popcorn holders are constructed of several parts that may be separated to provide for ease in cleaning.

Thus, there exists a need for a food holder, that contains a lid, and that provides a portal for adding seasonings or toppings, while also providing a sealable method for distributing toppings or seasonings uniformly about the contained food. In addition, thee further exists a need to provide the foregoing while providing a container that may be assembled or disassembled with ease to provide a convenient and easy way to clean and store the food container.

### SUMMARY

A food container is provided having a first portion being a bottom portion, a second portion being a top portion, and a lid, where the first portion, the second portion, and the lid form a hollow sphere.

A method of using the hollow sphere food container is provided, where the method includes: assembling a top portion, a lid, and a bottom portion to form a spherical container; opening the lid for placing food within the container; adding a food additive into the container; closing the lid of the container; and rotating the closed spherical container to distribute the food additive among the food within the container.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a side view of the food container fully opened illustrating the bottom portion 101 having a flat bottom 102, a top portion 103, a finger recess 107, and a lid 104.

FIG. 2 is a three-dimensional view of the food container fully assembled and closed view showing the lid 104 tightly shut or snapped tightly to the top/upper portion 103, and the bottom portion 101, a finger recess 107, and connected to form a spherical food container;

FIGS. 3A-3C provide a transparent view of the assembled food container fully assembled and closed. FIG. 3A is a transparent side view showing the bottom portion 101 having a flat bottom 102 and a fin 301. The bottom portion 101 is connected to the top portion 103 having a lid 104 that is shut. As shown, the connection is by way of a hinge; however, it is appreciated that various pivotable joinders are operative herein. These other joinders include a ball and socket or a pivot pin. FIG. 3B is a transparent top view showing the top portion 103 having a lid 104. The lid 104 is connected to the top portion 103 by a hinge 303, and the lid 104 has a lip 302 for ease of opening the lid 104 of the food container. Also illustrated is the fin 301 of the bottom portion 101. FIG. 3C is a transparent rear view of the food container showing the bottom portion 101 having a flat bottom 102 and a fin 301. The bottom portion 101 is connected to the top portion 103, where the top portion has a lid 104 in the shut position. The lid 104 is connected to the top portion 103 by a hinge 303.

FIG. 4 is a three-dimensional view of the container assembled showing the bottom portion 101, a top portion 103, and a lid 104, where the lid 104 is opened for the addition of a food additive or to otherwise add or remove contents from the container. The bottom portion 101 has at least one bottom portion tab 401. The top portion 103 has at least one top portion tab 402 for mating with the bottom portion tab 401 and a hinge 303 for connecting the lid 104. The lid 104 has a lip 302 to assist with opening the lid 104 from the top portion 103 of the container.

FIG. 5A is a three-dimensional view of the container of FIG. 2 with the lid 104 closed.

FIG. 5B is a three-dimensional view of the container of FIG. 2 with the lid 104 closed.

FIG. 5C is a three-dimensional view of the container of FIG. 2 with container disassembled to its constituent parts.

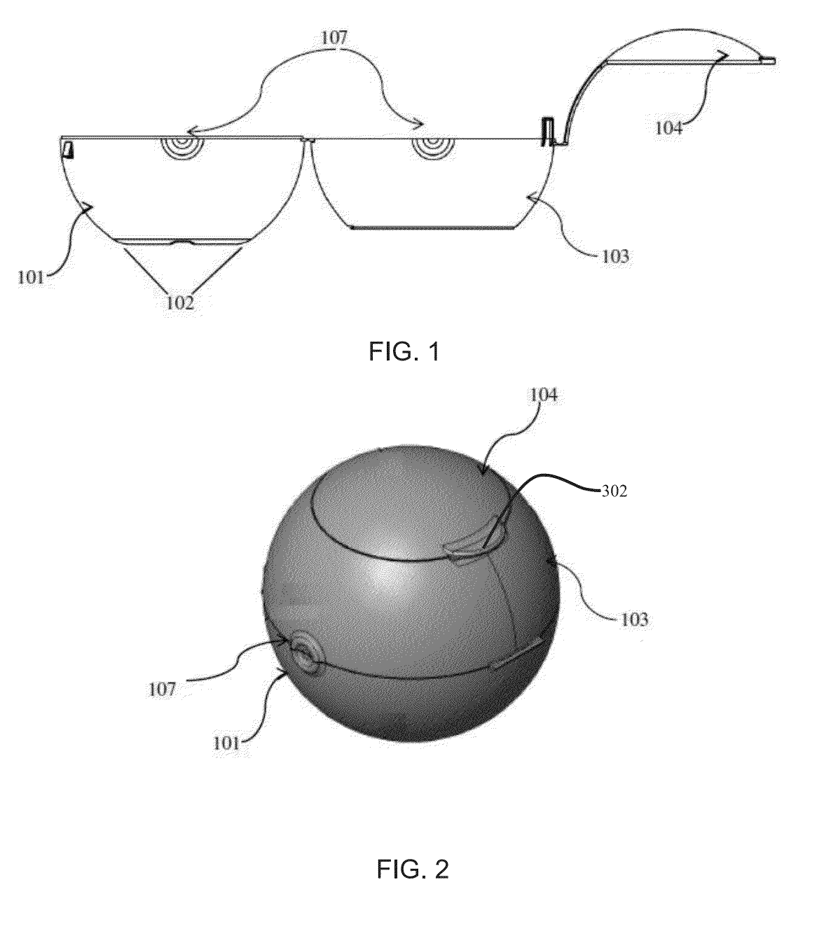

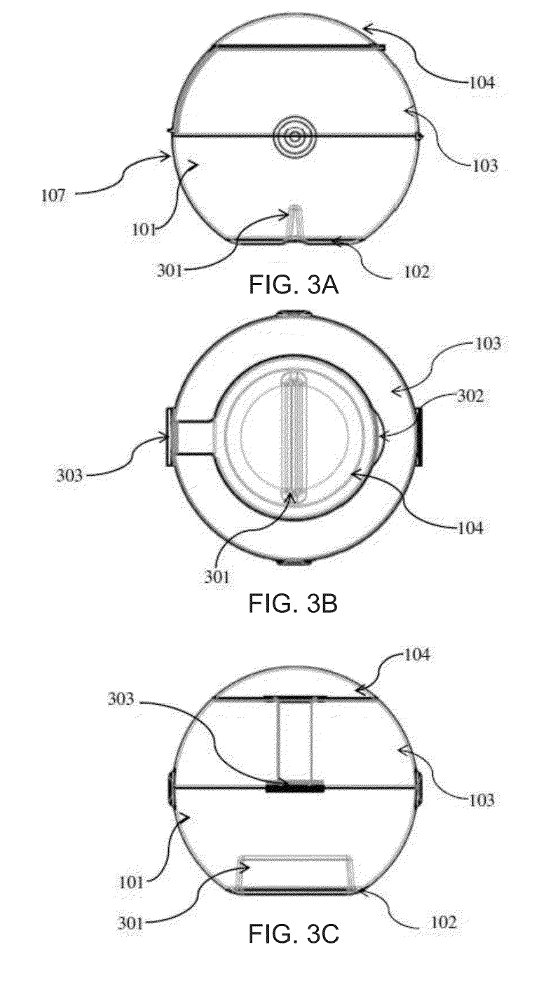

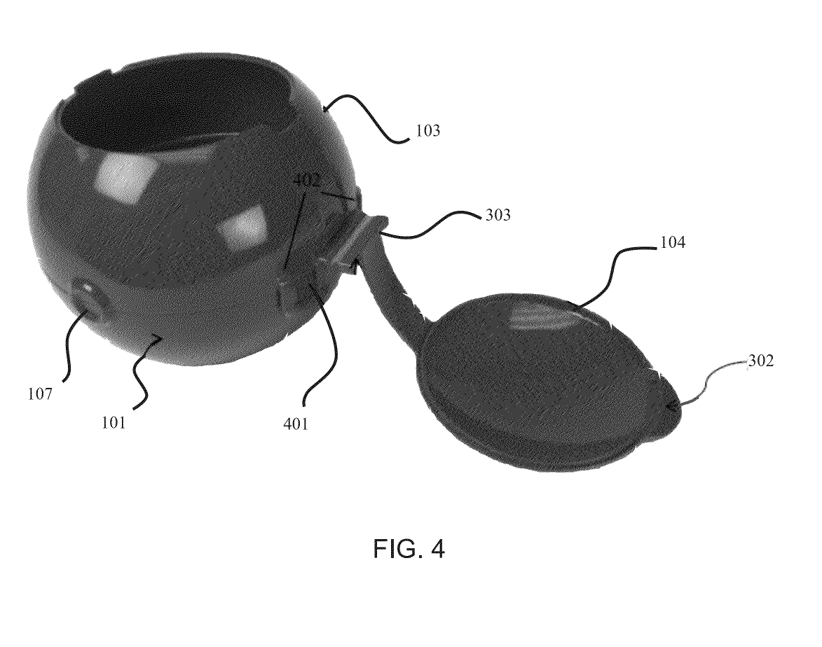

### DESCRIPTION OF THE PREFERRED EMBODIMENTS

The following detailed description is merely exemplary in nature and is in no way intended to limit the scope of the invention, its application, or uses, which may vary. The invention is described with relation to the non-limiting definitions and terminology included herein. These definitions and terminology are not designed to function as a limitation on the scope or practice of the invention, but are presented for illustrative and descriptive purposes only.

Various terms used throughout the specification and claims are defined as set forth below as it may be helpful to an understanding of the invention.

It is also noted that like numerals have the meaning ascribed thereto with respect to the preceding drawing throughout the figures shown.

A spherical food storage container with a lid for adding food additives, or for extracting food is provided. This application has utility in providing for a spherical food container that is stored as two or more pieces that may be assembled to form a spherical container for holding food, while providing a lid in a portion of one of the hemispheres for the addition of a food additive, or for extraction of the food.

The following description of the preferred embodiments of the invention is not intended to limit the invention to these preferred embodiments, but rather to enable any person skilled in the art to make and use this invention.

The present invention is a sphere shaped food storage container. The food container is made up of a top portion 103, a bottom portion 101 and a lid 104 to form a hollow hemisphere. In at least one embodiment, the container and the portions of the container are made of food grade plastic that is dishwasher safe. In at least one embodiment the food storage container is made from paper, cardboard, poly-vinyl chloride (PVC), plastic, ceramic, metal, wood, fiber glass, a glass reinforced plastic, or combinations thereof. The size of the container can vary to hold different volumes of popcorn. The exterior of the sphere can be design to look like a variety of items. For example: the DEATH STAR®, a basketball, a baseball, MICKEY MOUSE®, SUPERMAN® Logo, Football Helmet, etc. The food container may be used for many foods. Popcorn, for example, where the popcorn is placed inside along with other ingredients such as butter, salt, and seasoning. Once all the ingredients are inside container with the popcorn the lid 104 is closed and the container is rotated to apply the seasonings thoroughly. The lid 104 is opened and the popcorn can be enjoyed from start to finish with the added salt, butter or other ingredients distributed among all the popcorn.

### Bottom Portion

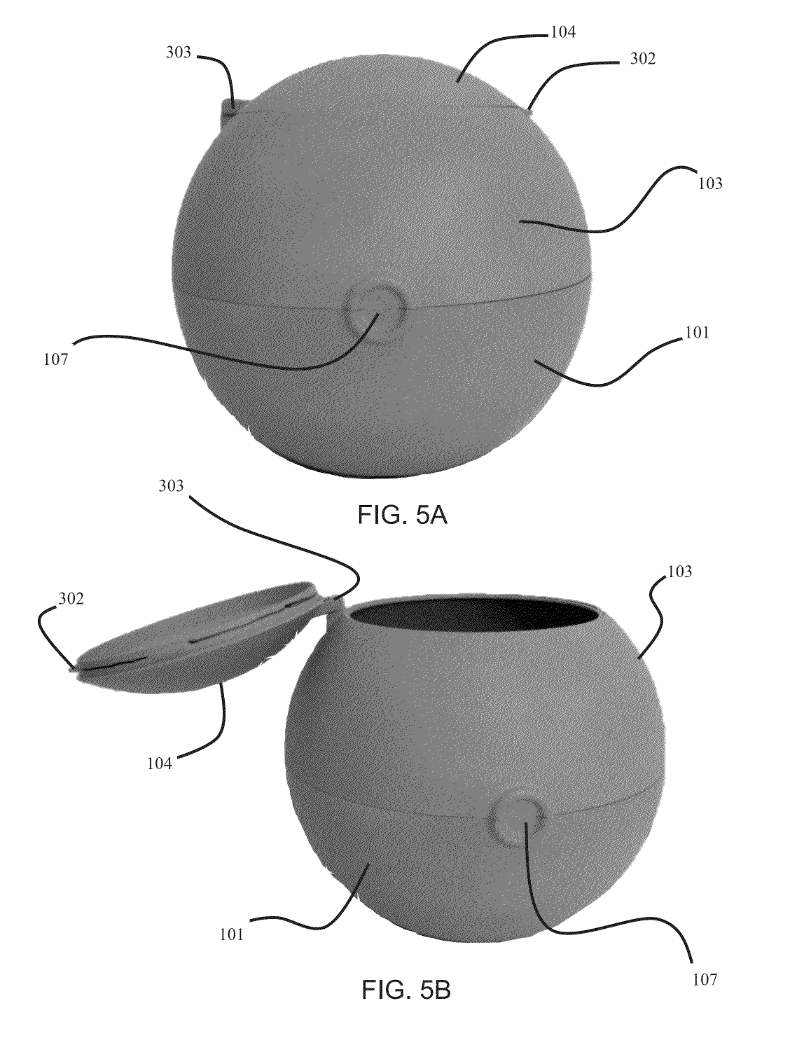

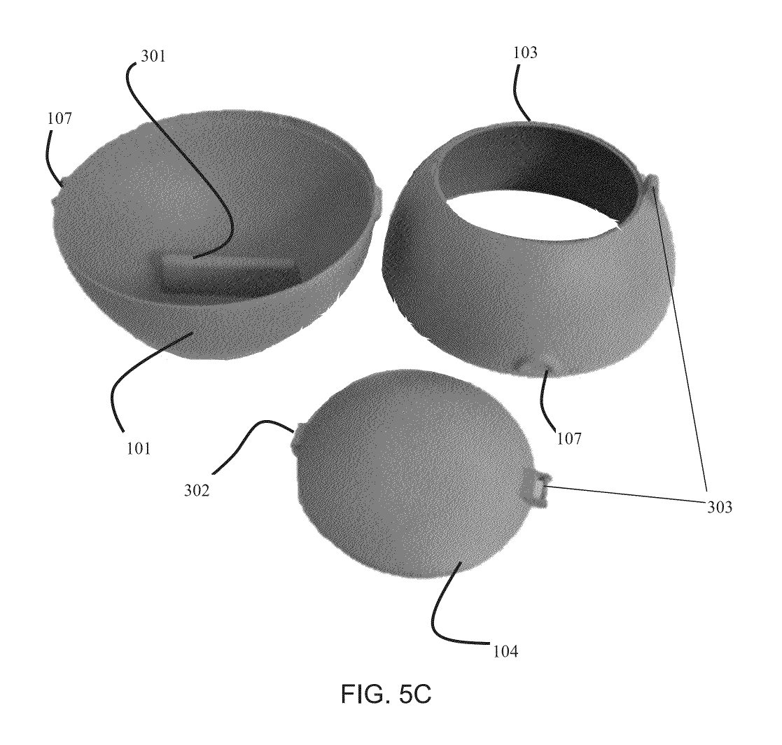

The bottom portion 101 of the container is for scooping or holding food contents and to form the bottom part of the container. In at least one embodiment the bottom portion 101 has a flat bottom 102 so that the food container may sit atop a flat surface without rolling. In at least one embodiment as shown in FIG. 4, the bottom portion 101 includes bottom tabs 401 to mate with the top tabs 402 on the top portion 103 to form a hollow hemisphere. It is appreciated that tabs function to retain the portions together. The finger recess 107 with diametrically opposed finger pressure along the joinder linier between the portions operates as an opener to release the tabs. In at least one embodiment, the inside of the bottom portion 101 has a fin 301 that runs along the inside surface of the bottom portion 101. The fin 301 is for assisting in the tumbling of the food contents to allow better distribution of any food seasoning or other topping or additive that may be added, so that there can be uniform distribution among the food contents. In one embodiment, the bottom portion 101 is of substantially the same shape of the top portion 103 for ease of stacking and storage.

### Top Portion

The top portion 103 of the food container is for mating with the bottom portion 101 of the container to contain a food. In at least one embodiment the top portion 103 has a lid 104. In at least one embodiment the top portion 103 is connected to a lid 104 using a hinge 303. In at least one embodiment the top portion 103 has top tabs 402 for mating with bottom tabs 401 on the bottom portion 101, thus tightly closing the top portion 103 to the bottom portion 101 to hold the food contents in a hollow hemisphere. In at least one embodiment, the lid 104 contains a lip 302 to allow ease of opening the lid 104 from the top portion 103. In at least one embodiment, the top portion 103 and the lid 104 form a hemisphere. In at least one embodiment the top portion 103 is of substantially the same shape of the bottom portion 101 for ease of staking and storage.

### EXAMPLES

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

### Example 1

The inventive food container is used for holding and storing popcorn and for evenly distributing salt and butter among the popcorn stored with the container. The top portion 103 is assembled to the bottom portion 101 using the mating or closing tabs 401,402 to form a hollow hemisphere. Next, the hinge 303 is connected to the lid 104 and to the top portion 103 of the container, but the lid 104 is left open. Popcorn is placed within the spherical container, then butter and salt is poured into the container. The lid 104 to the container is shut and rotated several times allowing for the butter and salt additives to travel along the inside of the container and mixing with the popcorn within the container. The popcorn within the container is also moved about within the container whereby the fin 301 provides a tumbling motion of the popcorn to better distribute the salt and butter additives. The container is set on a table upon the flat bottom 102 and the lip 302 of the lid 104 is used to open the container. The popcorn is then enjoyed, where a substantial portion of the popcorn received the salt and butter toppings instead of only the top layer of popcorn receiving all the additives.

### Example 2

Example 1 is repeated, however the salt and butter additive is added to the container before the popcorn.

### Example 3

Example 1 is repeated, however the salt and butter additive is poured along the inside surface after the container is filled with popcorn.

### Example 4

Similar to Examples 1-3, the inventive food container is used for holding and storing popcorn and for evenly distributing salt and butter among the popcorn stored with the container. The top portion 103 of the container is connected to a lid 104 through the use of a hinge 303. The lid 104 is snapped shut to form a tight seal to the top portion 103, and forming a closed hemisphere. The bottom portion 101 and the top portion 103 are then used as scoops to fill the bottom portion 101 and top portion 103 with popcorn, and then the bottom portion 101 and the top portion 103 are assembled to form a sphere using the mating or closing tabs 401, 402 to hold the container together. The lid 104 is opened using the lip 302 and butter and salt is added to the container. The lid 104 to the container is shut and rotated several times allowing for the butter and salt additives to travel along the inside of the container and mixing with the popcorn within the container. The popcorn within the container is also moved about within the container whereby the fin 301 provides a tumbling motion of the popcorn to better distribute the salt and butter additives. The container is set on a table upon the flat bottom 102 and the lip 302 of the lid 104 is used to open the container. The popcorn is then enjoyed, where a substantial portion of the popcorn received the salt and butter toppings instead of only the top layer of popcorn receiving all the additives.

### Other Embodiments

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

1. A food container comprising:
a first portion being a bottom portion;
a second portion being a top portion; and
a lid.

2. The food container of claim 1 wherein the said first portion, said second portion, and said lid form a sphere.

3. The food container of claim 1 wherein an exterior of said bottom portion further comprises a flat bottom.

4. The food container of claim 3 wherein the exterior of said bottom portion further comprises tabs for interconnecting said top portion to said bottom portion.

5. The food container of claim 1 wherein an interior of said bottom portion further comprises a fin axially along a portion of said bottom portion.

6. The food container of claim 1 wherein said lid forms a portion of said top portion.

7. The food container of claim 1 wherein said lid is hinged.

8. The food container of claim 1 wherein said lid snaps tight to said top portion when closed, enclosing the contents within said top portion and said bottom portion.

9. The food container of claim 1 wherein said lid and said top portion combine to form a hollow hemisphere.

10. The food container of claim 1 wherein said top portion, said bottom portion, said lid, said fin and said tabs are made from cardboard, paper, silicone, clay, ceramic, poly vinyl chloride (PVC), plastic, wood, metal, or combinations thereof.

11. A method of using the food container of claim 1 comprising:
assembling a top portion, a lid, and a bottom portion to form a spherical container;
opening said lid for placing food within said container;
adding a food into the container;
closing the lid of the container; and
rotating the closed spherical container to distribute the food additive among the food within said container.

12. A method of using the food container comprising:
assembling a top portion, a lid, and a bottom portion to form a spherical container;
placing food within the bottom portion, the top portion, or both;
assembling the top portion and the bottom portion to form a spherical container
opening said lid and adding a food into the container;
closing the lid of the container; and
rotating the closed spherical container to distribute the food among the food within said container.

13. The method of claim 12 wherein said food is popcorn.

14. The method of claim 13 wherein said food is salt, butter, powdered cheese, spices, caramel, chocolate, sugar, artificial sweetener, or combinations thereof.
